(19) United States
(12) Patent Application Publication
(10) Pub. No.: US 2004/0199391 A1
(43) Pub. Date: Oct. 7, 2004

(54) Portable voice/letter processing apparatus

(76) Inventors: Tae-Soo Yoon, Yuseong-gu (KR); Hoon Choi, Yuseong-gu (KR)

Correspondence Address: VENABLE, BAETJER, HOWARD AND CIVILETTI, LLP, P.O. BOX 34385, WASHINGTON, DC, 20043-9998, US

(21) Appl. No.: 10/477,947

(22) PCT Filed: May 14, 2002
(86) PCT No.: PCT/KR02/00893

(30) Foreign Application Priority Data
May 8, 2001 (KR) 2001-27432

(51) Int. Cl. G10L 21/00; G01L 13/00; G10L 11/00

(52) U.S. Cl. 704/275; 704/272

(57) ABSTRACT

A portable voice/letter processing apparatus includes an input unit for receiving input data: a storing unit for storing compressed data: a control unit for generating a control signal so that the compressed data is retrieved based on the user data: and an output unit for decompressing retrieved data and outputting a decompressed data to the user.

### TECHNICAL FIELD

The present invention relates to portable voice/letter message processing apparatus, in particularly, to a portable apparatus for searching data according to an input signal and outputting various types of data such as outputting voice, letters or both voice and letters as a search result.

### BACKGROUND ART

Goods such as dolls/toys, fancy/gifts, spiritual gifts and collectibles, novelty & souvenir, wedding gifts, funeral supplies and living supplies, have been produced for only one function or purpose. In other words, doll/toys, fancy/gifts and spiritual gifts and collectibles are visual enjoyment and bedding supplies are for using a functionality of the bedding supplies.

For example, a pillow, cushion and cradle for infant has been used for using functionalities of them and the novelty & souvenir such as HA-LOO-BANG and DA-BO-TAB is for visual enjoyment. A diary for raising an infant usually is written on papers or written on a hard disk or floppy diskette as a file by using a computer. An infant's voice has been recorded and stored by using a cassette player and a cassette tape.

Recently, a talking toy have been produced in world wide, however, functionalities of talking toy such as speech recognition, audio record and play back are in very beginning-level.

Generally, toys have two functional aspects, enjoyment and educational effect to children. The toys have been developed based on providing to satisfy curiosity of the children but nowadays, educational effect of the toys has been emphasized and it influences to development of the toys.

Specially, an interactive toy reacts to various voices and movements of infant or child and performs corresponding reactions such as taking or acting. Therefore, such the interactive toy satisfies curiosity of the infant or child and also gives educational affection. Therefore, the interactive toys have been popular recently. The interactive toy including “talking toy” generally have a touch sensor installed and gives simple voice response, which is recorded in IC or tape, or performs some simple actions according to signal detected by the touch sensor. However, low cost voice output device usually is used in the interactive toy so voice response of the interactive toys is hardly understood since low quality of the voice output device and users cannot access voice interactive data in the interactive toy. The child easily becomes bored to play with the interactive toy because of its simple responses.

In a meantime, a database, which is voice and letter searchable, has been constructed differently and used in accordance with a purpose of the system using the database.

In case of automatic voice response system used in a telephone system, recorded information is played according to input of a certain key. At this time, voice signals are encoded by an adaptive differential pulse code modulation (ADPCM) and are outputted to the telephone network.

According to the number of simultaneously accessing to a system, a capacity of the system is decided and for providing better service, the capacity of the system must be huge. And a hard disk or database resident memory is used as the database of the telephony system. In the above-mentioned structure of database, audio information excepting an index for searching is managed as a file. For managing database as a file, it is necessary to used high performance computer system or micro processor for fast information processing and such a high performance system is hard to implement into a low cost product.

### DISCLOSURE OF THE INVENTION

It is, therefore, an object of the present invention to provide a voice/letter processing apparatus for searching various information according to user's request and outputting searched information in various types.

It is another object of the present invention to provide a voice/letter processing apparatus for minimizing power consumption and miniaturizing the apparatus in order to carry around.

It is still another object of the present invention to provide a voice/letter processing apparatus for outputting the searched data in various forms such as voice or letter.

It is further another object of the present invention to provide a voice/letter processing apparatus for easily and simply inputting, searching and outputting data of voice or letter.

In accordance with an aspect of the present invention, there is provided a method for a portable voice/letter processing apparatus, including of: input unit for receiving data from outside; store unit for storing compressed data; control unit for generating a control signal in order to search data stored by the store unit according to data inputted from the input unit; and output unit for recovering the compressed data to be recognized by the user according to the control signal and outputting the recovered data.

### BRIEF DESCRIPTION OF THE DRAWINGS

The above and other objects and features of the present invention will become apparent from the following description of the preferred embodiments given in conjunction with the accompanying drawings, in which:

FIG. 1 is a diagram illustrating a structure of a potable voice/letter outputting apparatus in accordance with a preferred embodiment of the present invention;

FIG. 2 shows a front view of the preferred embodiment of the present invention;

FIG. 3 is a flowchart explaining a voice language input/output system in accordance with the preferred embodiment of the present invention;

FIG. 4 is a flowchart showing steps of switching to low power consumption mode;

FIG. 5 is a table showing names and functions of the selection key, function key and numeral key in accordance with the preferred embodiment of the present invention;

FIG. 6 is diagram illustrating a structure of a voice database;

FIG. 7 is a diagram illustrating a portable output apparatus in accordance with another embodiment of the present invention;

FIG. 8 is a detailed diagram of the main processor in FIG. 7;

FIG. 9 is a diagram illustrating another preferred embodiment of voice/letter output apparatus;

FIG. 10 is a detailed diagram illustrating a main processor in FIG. 9;

FIG. 11 is a diagram illustrating a potable voice output apparatus in accordance with another embodiment of the present invention;

FIG. 12 is a detailed diagram illustrating the main processor in FIG. 11;

FIG. 13 is a diagram illustrating a portable voice/letter output apparatus in accordance with another preferred embodiment of the present invention;

FIG. 14 is detailed diagram illustrating the main processor in FIG. 13;

FIG. 15 is a diagram illustrating a voice composition program apparatus for inputting voice information and control program into a portable voice/letter output apparatus in accordance with the present invention;

FIG. 16 is a block diagram showing the voice composition program apparatus in FIG. 15;

FIG. 17 is a diagram illustrating a multi-language voice conversion device of a translation robot engine in accordance with the preferred embodiment of the invention;

FIG. 18 is a block diagram illustrating software functionality of multi-language voice conversion device in a digital joy translation robot engine;

FIG. 19 is a table illustrating examples of a random switch in accordance with the present invention;

FIG. 20 is a table explaining a voice input method of each layer used by voice in accordance with the preferred embodiment of the present invention; and

FIG. 21 is a table explaining and text input method of each layer used by a menu bar in accordance with the preferred embodiment of the present invention.

### MODES FOR CARRYING OUT THE INVENTION

Other objects and aspects of the invention will become apparent from the following description of the embodiments with reference to the accompanying drawings, which is set forth hereinafter.

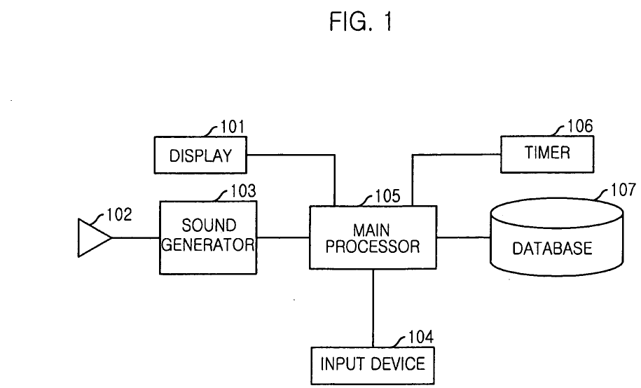

FIG. 1 is a diagram illustrating a structure of a potable voice/letter outputting apparatus in accordance with a preferred embodiment of the present invention.

Referring to FIG. 1, the potable voice/letter outputting apparatus includes a main processor 105 for controlling all functions, a timer 106 for providing time information to the main process, a input device 104 for receiving signal from a user, a database 107 for storing compressed voice and letter information, a sound generator 103 for transforming data to outputtable voice, a voice output device 102 such as a speaker or earphone and a display 101 for outputting a letter.

The timer 106 regularly notices time information to the main process 105 by generating a signal after elapsing a certain time or passing a specific time.

The input device 104 receives input signal such as key input or pen input and transmits the received signal to the main processor 105. The input device 104 can be used as various type of device including a keypad, a voice input device or a sensor.

The various sensors can be used in the present invention such as a touch sensor for detecting any touch of the apparatus and sending an on/off signal to the main processor 105, a ultrasonic sensor for detecting a distance between the apparatus and a user and sending an on/off signal to the main processor, a infrared sensor for detecting a lightness and darkness and sending an on/off signal to the main processor.

The main processor 105 receives user input through the input device 104, searches a desired information in the database 107 and outputs voice corresponding to the searched information through the sound generator 103 or outputs letters corresponding to the searched information through display 101. The user input can be displayed on the display 101 for correcting a user's input error. The database 107 stores output information including voice and letter and can be implemented by using a ROM or Flash memory.

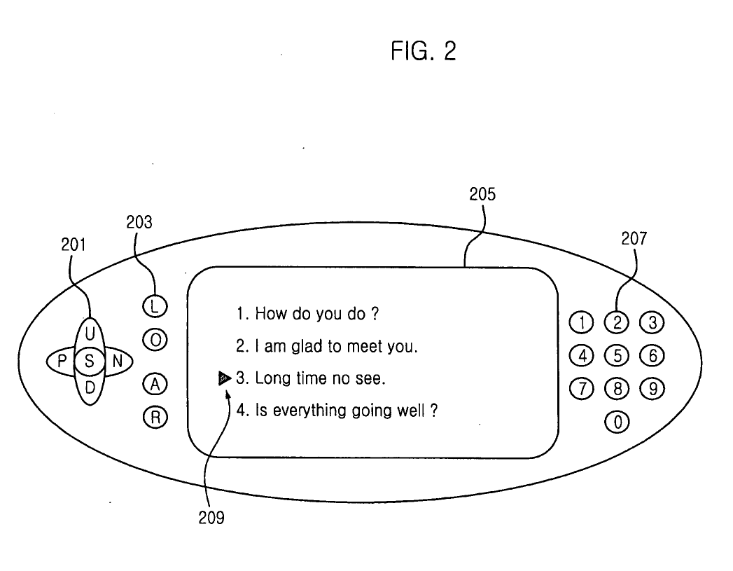

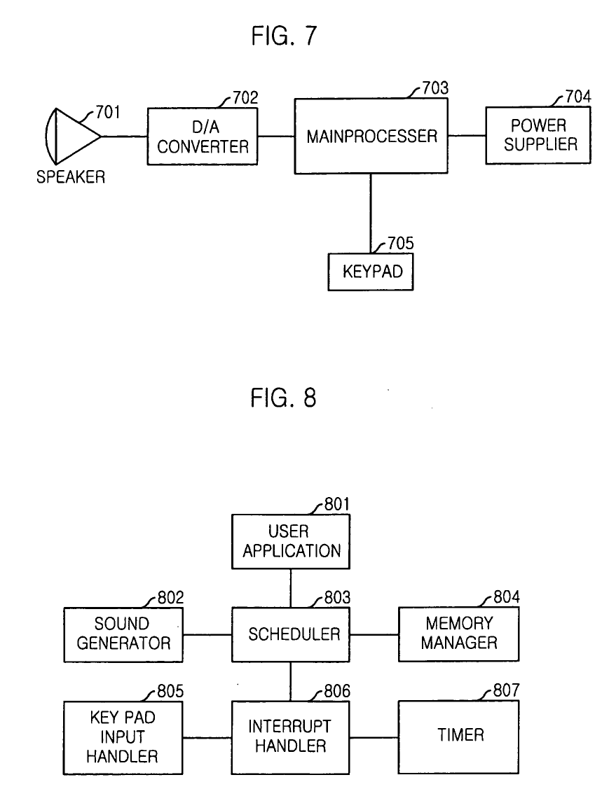

As referring to FIGS. 2 to 6, the potable voice/letter output apparatus in accordance with the present invention is explained and another preferred embodiments of the present invention are explained as referring to FIG. 7 to 21.

FIG. 2 shows a front view of the preferred embodiment of the present invention.

As referring to FIG. 2, the front side of the present invention includes a selection key for information search, a function key 203 for setting information output type, a letter information output window 205 and a numeral key 207 for inputting numeral information. In the letter information output window 205, a cursor 209 for indicating location of selected sentence is included.

A user selects the output type by using the selection key 201 and searches desired data in the database by using the function key 203. The searched data is outputted on the letter output information window 205 according the selected output type. Usually, various types of data are displayed on the window for providing choices to user.

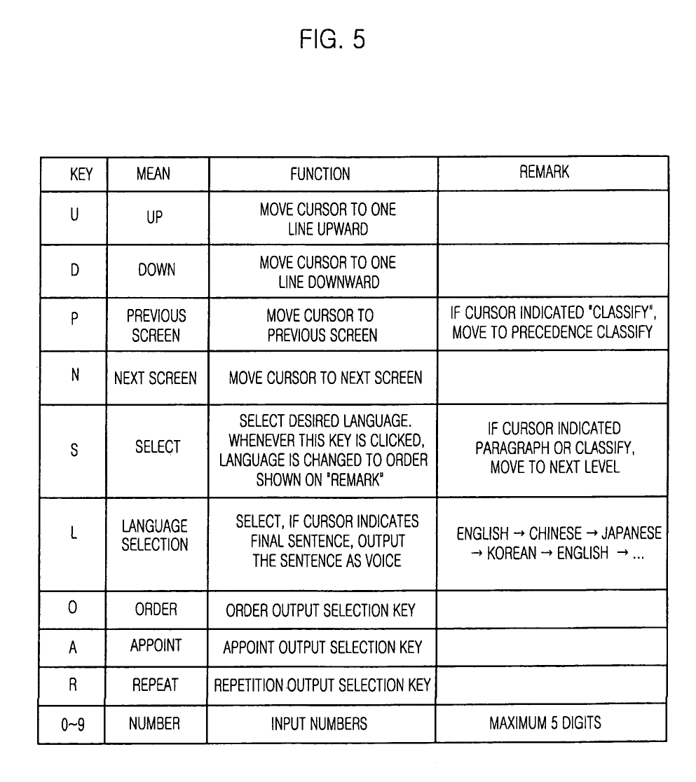

Names and functions of the selection key 201 and function key 203 for searching information and selecting the output type will be explained in later with FIG. 5.

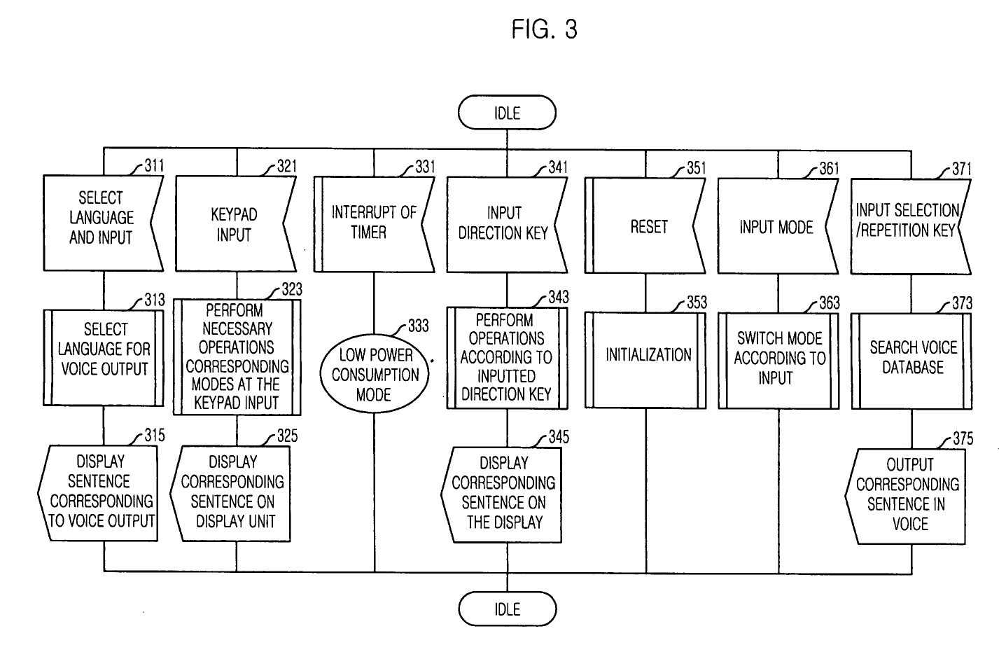

FIG. 3 is a flowchart explaining a voice language input/output system in accordance with the preferred embodiment of the present invention.

As referring to FIG. 3, the voice language input/output system is in an idle mode for waits any type of input as an idle mode at step 301. If the system receives a keypad input at step 321, the voice input/output system performs necessary operations corresponding modes of the keypad input at step 323 and after necessary operations are performed, the system goes back to the idle mode again. At the step 323, the system displays a sentence indicated by an input number according to a current mode at step 325.

The mode is switched at step 363 according to input of a mode selection keypad at step 361 and an assigned output mode and consecutive output mode is also selected according to input of the mode selection keypad. In the assigned output mode, inputted sentence number is a unique number assigned each sentence and in the consecutive output mode, the input number is a number of paragraphs. The paragraph contains sentences under same subject.

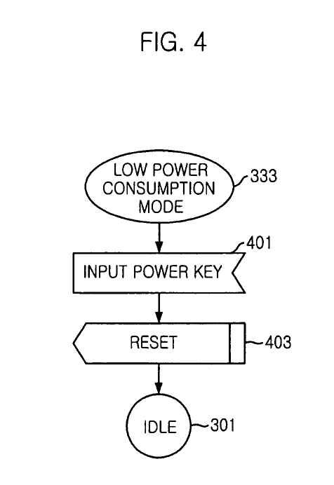

In case of elapsing a low power consumption timer at step 331, a mode of the system is switched to low power consumption mode at step 333. FIG. 4 is a flowchart showing steps of switching to low power consumption mode. Referring to FIG. 4, if the system is in the low power consumption mode and a power key is inputted at step 401, the mode is switched to idle or wait mode 301 by passing through a reset mode 403.

If a language selection key is inputted at step 311, a language for outputting voice is selected at step 313, corresponding sentence is displayed in the selected language at step 315. After outputting voice and displaying the sentence, the system goes back to idle mode at step 301.

If a direction key is inputted at step 341, a current cursor location is moved according to inputted directional key, that is selection of the sentence is changed, at step 343, and the cursor indicates the newly selected sentence and displays it on the display at step 345.

If the system is reset by the operation of the power key at step 351, the system is initialized at step 353 and the goes back to the idle mode (301).

If the selection or repetition key is inputted at step 371, the system searches a sentence or paragraph currently indicated by the cursor at step 373 and outputs the indicated sentence or paragraph as voice through the sound generator 103. In the assigned output mode, the assigned number of the sentence is searched and outputted. In the consecutive output mode, the selected paragraph or sentences are searched by the search function and is outputted. The repetition key is used for controlling the number of outputting sentence or paragraph, which is currently indicated by the cursor.

FIG. 5 is a table showing names and functions of the selection key, function key and numeral key in accordance with the preferred embodiment of the present invention.

A key named as “U (Up)” moves a cursor to upward by one line. A key named as “D (Down)” moves the cursor downward by one line. “P(Previous Screen)” moves a current cursor location to previous location of the cursor and if the cursor indicates “menu”, “p” moves the cursor to up-level “menu”. A key named as “S(select)” selects sentence or menu indicated by the cursor and if the cursor indicates the sentence, voice corresponding indicated sentence is outputted by clicking “S”. If the cursor indicates a paragraph or the menu, corresponding sentence, paragraph or the menu are shown on the display by clicking “S”. A key named “L(Language Selection)” is for selecting a type of the language. If “L” key is selected and clicked, language is switched followed by prefixed order such as Korean→English→Japanese→Chinese→German.

A key named “O(Order)” is a selection key for a consecutive output mode. If “O” is clicked, the selected sentence is switched to other language followed by a pre-fixed order. A key named “A(Appoint)” is a selection key for the assigned mode. If “A” is clicked, the selected sentence is outputted and displayed in previously selected language. “R(Repeat)” is a repetition output selection key. If “R” is clicked, the selected sentence is outputted as many as pre-fixed number. Keys named “0”-“9” are numeral keys.

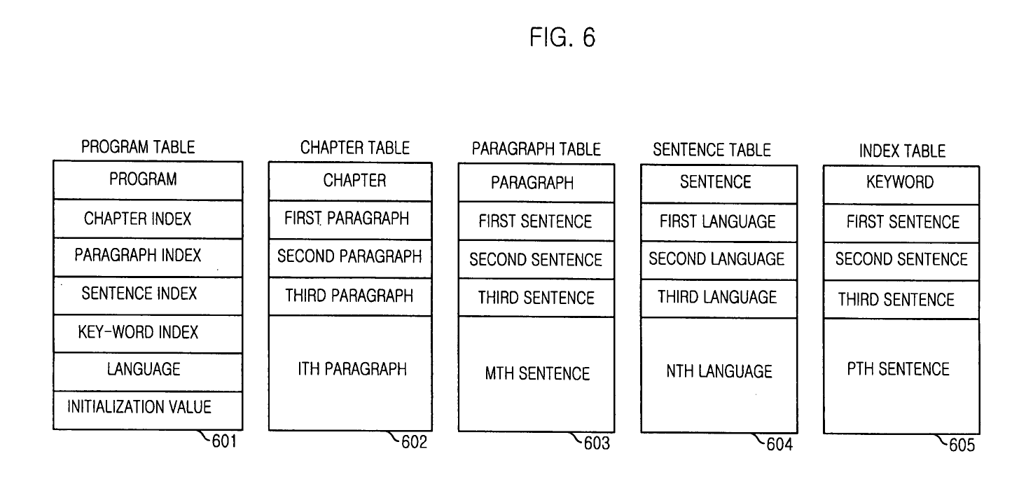

FIG. 6 is a diagram illustrating a structure of voice database. For example, it shows a storage structure and index structure of voice or letter signals.

A program table 601 contains and manages information of language such as size and location of a unit table, paragraph table, sentence table and index table, and system initialization information.

The unit table 602 contains and manages information of size and location of paragraph and sentence included in the unit.

The paragraph table 603 contains and manages content of the paragraph and information of a paragraph and sentence including to other paragraph.

The sentence table 604 contains and manages information of the sentence including letters, voice information or pronunciation information.

The index table 605 contains and manages location of sentence having index words and content of the index word. The voice information is identical to the number of the language defined in the program table 601.

The database is constructed as an index table structure for easy accessing from ROM structure and contains a table having an accessing address of the ROM for minimizing an accessing time.

Also, a unique number is assigned to each sentence, paragraph and unit for directly accessing to sentence, paragraph or unit. Such a functionality of the direct accessing can minimize accessing time of the database (601, 602, 603, 604).

A unique number is also assigned to each index word for accessing the index table and for accessing each sentence from the whole sentence having the index word.

For making the system leaner and lighter, the voice information is encoded and compressed for storing in the database and the encoded and compressed voice information is converted to the original voice information by the sound generator 103 for outputting the voice. The table size is managed not to occupy unnecessary space of the memory.

The sentence table can be accessed by accessing the paragraph table 603 through the unit table 602 and using information of the paragraph table 603. The sentence table can be also accessed by using the index table 605 and using a unique number of sentences.

In case of using the unit table 602, the sentence can be accessed by selecting the unit displayed on the display, selecting the paragraph included in the unit and finally selecting a desired sentence in the selected paragraph.

In case of using the index table 605, the sentence can be accessed by searching the sentence according to index word, displaying searched sentences on the display and selecting a desired sentence among searched sentences. In this case, the sentence table 604 of multi-languages can be accessed too.

Hereinafter, other preferred embodiments of the present invention are explained in detail as referring to FIGS. 7 to 22.

The portable voice/letter processing apparatus in accordance with the present invention can perform various functions according to input/output devices.

FIG. 7 is a diagram illustrating a portable output apparatus in accordance with another embodiment of the present invention. It is similar to the apparatus in FIG. 1 excepting that the portable output apparatus in FIG. 7 uses a voice output device as an output device and a keypad as an input device.

Referring to FIG. 7, data is searched according to information inputted by the keypad 705, the searched data is converted from digital to analog by a D/A converter 702 and outputting the result through a speaker 701.

The speaker 701 performs same functionality of a voice output device 102 in FIG. 1 and the D/A converter 702 converts search data, which is a digital signal outputted form the main processor 703. The main processor 703 performs same functionality of a main processor in FIG. 1 and the main processor 703 can have a power source such as 2 AAA batteries or a rechargeable battery.

FIG. 8 is a detailed diagram of the main processor in FIG. 7.

A user application 801 is for outputting compressed voice information in voice according to prefixed conditions. Programmed voice information is outputted by elapsing various types of timers or according to key input through a keypad input handler 805. That is, the user application 801 is a program directly controlling time or guidance message.

A sound generator 802 decodes a compressed voice code in a ROM, transforms the decoded compressed voice code in order to be processed in a D/A converter and passes to the D/A converter. Through the sound generator 802, voice information is stored and managed by a memory manager 804 and information requested by the user application 801 is provided.

A scheduler 803 controls to consecutively operate between a program of a system level and program of a user level without any conflict. An interrupt handler 806 processes interrupts from the timer 807 or keypad input in real time and notices interrupt from the timer or keypad input to the scheduler 803.

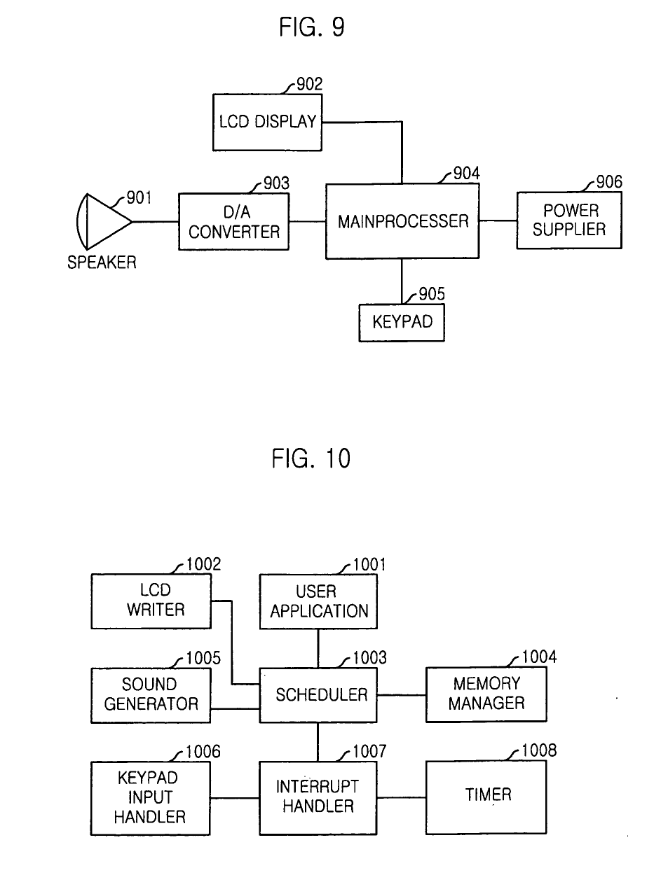

FIG. 9 is a diagram illustrating another preferred embodiment of voice/letter output apparatus. The embodiment of the present invention shown in FIG. 9 is a case of equipping a keypad as input device, a voice output device as an output device and LCD as a displayer with the potable voice/letter processing apparatus shown in FIG. 1.

The voice/letter output apparatus in FIG. 9 is very similar to the apparatus in FIG. 7 except the LCD displayer 902. Detailed explanation of each element of the voice/letter output apparatus in FIG. 9 is omitted since functionalities of the elements of the voice/letter output apparatus in FIG. 9 are identical to the apparatus in FIG. 7.

Voice and letter data corresponding to user's keypad input is outputted to a speaker 901 and a LCD displayer 902 at the same time. Also, data inputted by a user are displayed on the LCD displayer in real time. And, a replay means (not shown) may be included for repeatedly outputting desired voice data among outputted voice data.

FIG. 10 is a detailed diagram illustrating a main processor in FIG. 9.

A user application 1001 has identical function of a user application 801 in FIG. 8 and output control function using LCD display 902 is additionally included.

A LCD writer 1002 performs to display letter font on the LCD display 902.

Since a sound generator 1005, scheduler 1003, memory manager 1004, key pad input handler 1006, interrupt handler 1007 and timer 1008 performs same rolls of the sound generator 802, scheduler 803, memory manager 804, key pad input handler 805, interrupt handler 806, and timer 807 in FIG. 8, detailed explanations of the elements is omitted.

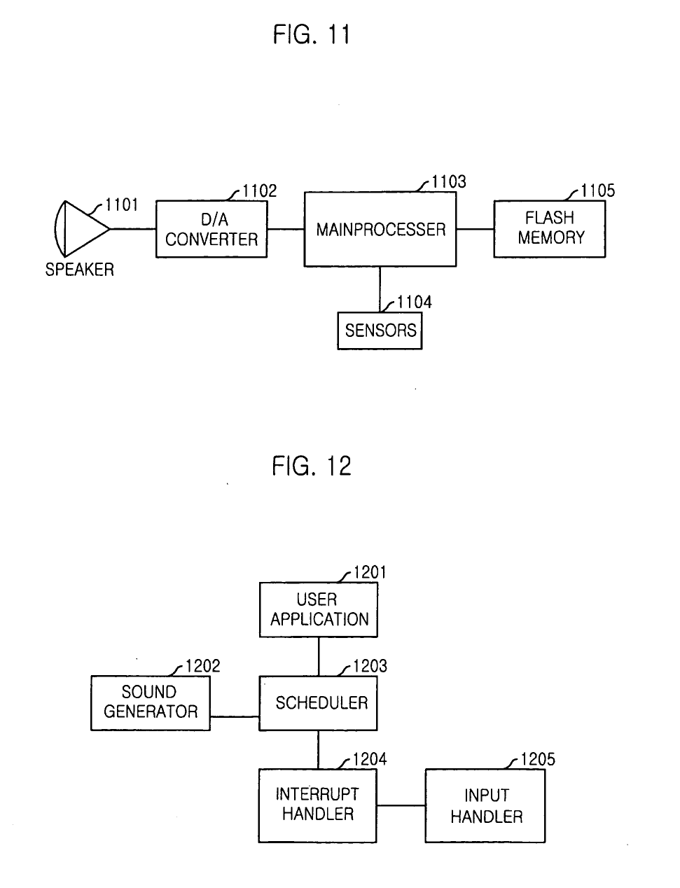

FIG. 11 is a diagram illustrating a potable voice output apparatus in accordance with another embodiment of the present invention. The portable voice output apparatus in FIG. 11 uses a sensor as input device and a voice output device as an output device based on the apparatus in FIG. 1. As mentioned above, various types of sensor can be used in the portable voice output apparatus in FIG. 11.

A speaker 1101, D/A converter 1102 and main processor 1103 have identical functions of the speaker 701, D/A converter 702 and main processor 703 in FIG. 7 therefore, detailed explanations are omitted.

Various types of sensor including a keypad, microphone, impact sensor, ultrasonic sensor and gravity sensor can be used as the sensor 1104. The main processor 1130 searches data stored in a Flash memory 1105 based on information inputted by the sensor 1104 and outputs the searched information through the D/A converter 1102 and speaker 1103.

FIG. 12 is a detailed diagram illustrating the main processor in FIG. 11.

Referring to FIG. 12, a user application 1201 has similar functionality of the user application 801 in FIG. 8 and outputs voice information according to variation of condition of the sensor.

A sensor input handler 1205 is coupled to impact sensor, toggle, and switch, and detects a state of the sensor. It also transmits the detected state of the sensor or switch to an interrupt handler 1204.

Since a sound generator 1202, scheduler 1203, interrupt handler 1204 has identical functionalities to sound generator 802, scheduler 803, and interrupt handler 806 in FIG. 8, detailed explanations are omitted.

It is not shown but a LCD displayer may be included in the apparatus in FIG. 12 as an output device. In this case, a voice and letter corresponding to signal inputted by the sensor are outputted simultaneously. Data inputted by user is displayed on the displayer 101 in real time. A replay means (not shown) may be included for repeatedly outputting desired voice data among voice data outputted. It may further include a communication means (not shown) for accessing to Internet in order to search information through the Internet, play games, surf web and send an e-mail.

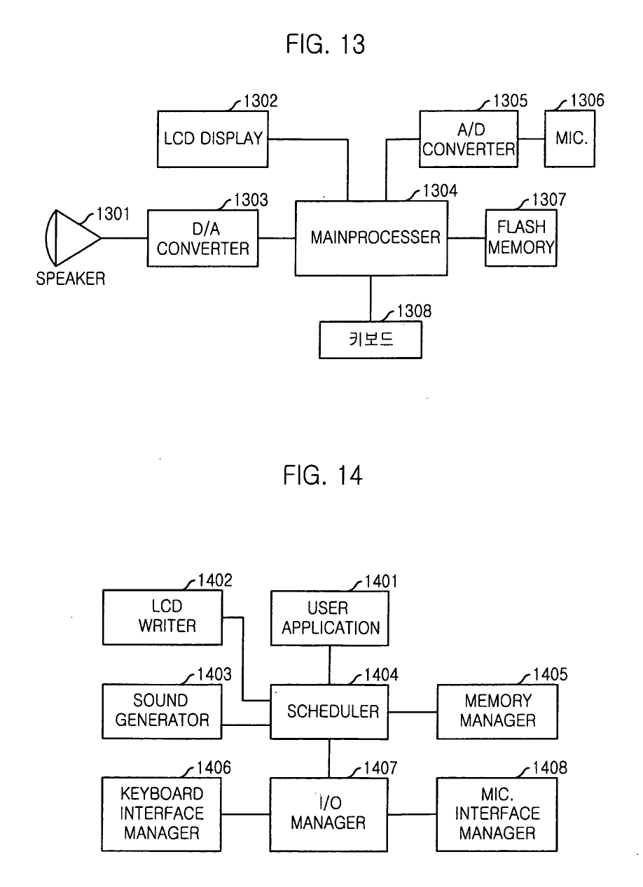

FIG. 13 is a diagram illustrating a portable voice/letter output apparatus in accordance with another preferred embodiment of the present invention. It further includes a function of recording data.

A mic 1306 converts voice signal inputted by a user to digital signal and an A/D converter 1305 converts analogue voice signal to digital signal.

A speaker 1301, LCD displayer 1302 and flash memory 1307 have identical functionalities to speaker 102, display 101 and database 107 in FIG. 1. The D/A converter 1303 has identical functionality to D/A converter 702 in FIG. 7, therefore, detailed explanations are omitted here.

FIG. 14 is detailed diagram illustrating the main processor in FIG. 13.

A user application 1401 is identical to the user application 801 of FIG. 8 except that it further includes functionalities of voice input, voice processing and voice recording. It includes a Speech Codec (not shown) for inputting, processing and recording voice.

A Mic interface manager 1408 divides voice input signal for processing the voice signal in a Speech Codec.

A memory manager 1405 includes a function of write for storing in a Flash ROM.

A LCD writer 1402, sound generator 1403, scheduler 1404 and keyboard interface manager 1406 have identical functionalities of LCD writer 1002, sound generator 1005, scheduler 1003 and key pad input handler 1006 of FIG. 10 therefore, detailed explanations are omitted.

An I/O manager 1407 passes voice signal outputted to the Mic interface manager 1408 to the scheduler.

A letter inputted by a user is converted to voice and outputs the voice or both letter and voice are outputted simultaneously. In this case, it may further include a letter/voice converter (not shown) for converting a letter to voice. The voice data converted by the letter/voice converter and letter data corresponding to the voice data is stored and the voice data only or voice and letter data is outputted according to a control signal of the main processor.

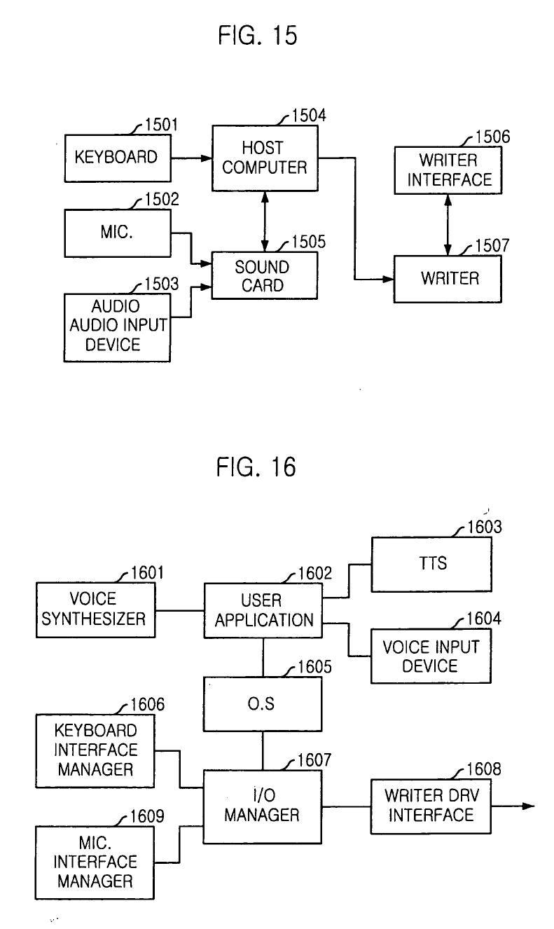

FIG. 15 is a diagram illustrating a voice composition program apparatus for inputting voice information and control program into a portable voice/letter output apparatus in accordance with the present invention.

A user's key input and voice data is received through a keyboard 1501 and Mic 1502. An audio input device 1503 receives voice signal from an audio source having recording function.

A voice signal passed through the Mic 1502 and audio input device 1503 is received through an audio card 1505, which is equipped in a computer, and converted to a digital signal.

A host computer 1504 controls all input/output signals and performs a function of audio composition in FIG. 16.

A writer 1507 is a recording device for recording voice information and control program in a ROM or Flash ROM in a basic model and a writer interface 1506 is an accessing device for accessing to the ROM.

FIG. 16 is a block diagram showing the voice composition program apparatus in FIG. 15.

An audio composition function 1601 decodes and compresses voice signal based on basic audio input information to a form for loading to the basic model.

The audio composition function 1601 reorganizes a specific sentence to voice by using voice input signal.

A text to speech conversion (TTS) 1603 converts a sentence with letters to voice.

If a voice signal is inputted from the Mic and converted to a digital signal, a voice input device 1604 divides the digital signal into a phoneme, syllable and word in order to process.

A user application 1602 controls to process voice input and composition.

An O.S 1605 is an operating system for the host computer.

A keyboard interface manager 1606 controls and processes keyboard input of the O.S.

A Mic interface manager 1609 processes input of Mic.Audio.

A writer Drv interface 1608 is a writer device driver of the O.S.

An I/O manager 1607 is same as I/O manager in O.S.

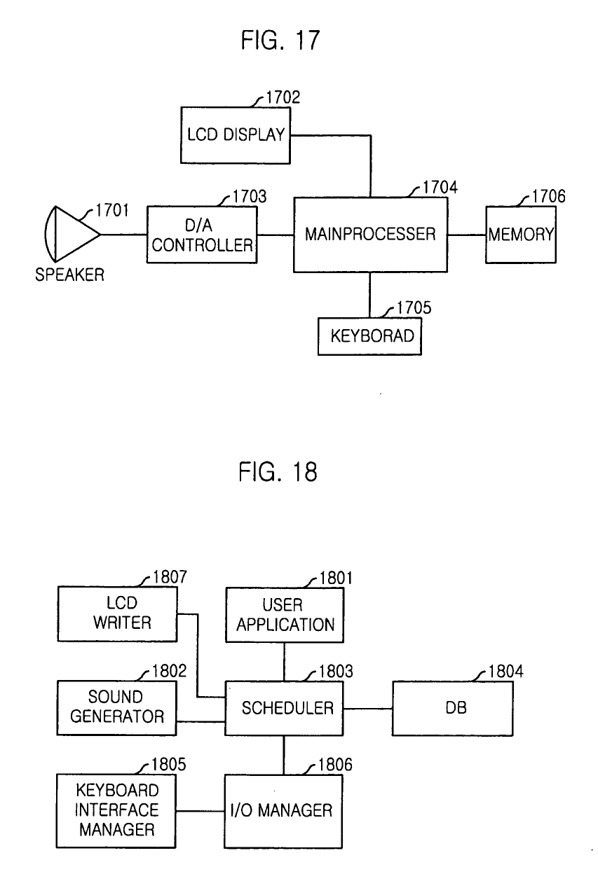

FIG. 17 is a diagram illustrating a multi-language voice conversion device of a translation robot engine in accordance with the preferred embodiment of the invention.

The multi-language voice conversion device converts a text type sentence to a voice, a voice to text type sentence or a voice to a voice in various languages by using a voice database.

In the preferred embodiment, a user's input is shown on a LCD displayer 1702.

A speaker 1701 is an output device of audio/voice information.

A LCD displayer 1702 is an output device of letter/sentence information.

A main processor 1704 controls all functions.

A keyboard 1705 is an input device for receiving user's letter input.

A memory 1706 is a storage device for storing control program and voice/audio information.

FIG. 18 is a block diagram illustrating software functionality of multi-language voice conversion device in a digital joy translation robot engine.

A user application 1801 includes a speech decoder (not shown) and adaptively outputs a compressed voice signal according to a result of sentence conversion.

A DB 1804 stores and manages voice information and text information and supports to match a meaning and voice according to various languages.

A sound generator 1802, scheduler 1803 and keyboard interface manager 1805 have identical functionalities with the sound generator 802, scheduler 803 and key pad input handler 805 in FIG. 8 and the LCD writer 1807 has same function with the LCD writer 1002 of FIG. 10. The I/O manager 1806 also has same functionality with the I/O manager 1407 in FIG. 14. Therefore, detailed explanations are omitted.

The multi-language voice conversion device receives a text input, translates input text to desired language and converts to voice information corresponding language (TTL function).

Also, the multi-language voice conversion device receives voice input, converts the received voice input to text in desired language and converts the text to voice in desired language.

According to a use of voice data, the number of outputting voice data, content of output or output time may be changed variously. For example, a voice/letter processing apparatus for use of self-studying rapidly outputs a sentence of foreign language corresponding a Korean sentence according to time information as many as a pre-fix number. An apparatus performing a functionality of assistance rapidly outputs a desired data in a Korean and corresponding foreign language in every prefix period for prefix times according to user's schedule.

In case of the random service setting up, the main processor 105 in FIG. 1 chooses a random service through a random number generator and outputs voice corresponding to predetermined situation according to the random number.

The present invention is explained as referring to FIG. 1 to 18, however, the present invention can be modified and changed to various types or forms according to fields where the present invention is implemented.

Applicable fields of the present invention can be divided by a generation. A first generation is a group of products having a function of one-way or two-way service. A second generation is a group of products having a function of pursuing a location of the product by combining a wireless communication technique with functions of the first generation. In a third generation, wired/wireless communication technique can be implemented in the product with the first and second generation's techniques. A fourth generation implements a satellite Internet networking system in the product and the product have functionalities of satellite Internet education, game and shopping.

A self-study device is one of products in the first generation.

Educational fields of the present invention is divided by age groups such as a juvenile group including infant, preschool, elementary school boys and girls, a youth group including middle school, high school students, employees and housewives.

A self-study paper, cassette tape, VCR tape and compact disk (CD) have been used as educational appliances for learning foreign language. A major market of the self-study paper is the juvenile group and the youth group and a major market of the cassette tape, VCR tape and CD is a collegiate and employee group.

At first, the self-study device for the juvenile group in accordance of the present invention is explained hereinafter.

For providing a method for self-studying foreign language to the juvenile group who are in early days of acquisition of language, the method must be child friendly.

The juvenile group has used conventional education method for self-studying foreign language such as self-study paper, tape, VCR or TV. Such the method is not adaptable to the juvenile group. New child friendly self-studying method is required.

Let's consider self-study device for the youth group.

Mostly, the self-study paper is major educational appliance for learning and studying foreign language and they arrange their study time for learning foreign language at home or a private institution. Most of students spend at least one hour for traveling school to home or vice versa. For using time spent as traveling, the students of the middle or high school have required a potable foreign language self-study device.

Therefore, the portable voice/letter processing apparatus in accordance with the present invention is produced as handy and portable for utilizing the time spent for traveling from school to home, home to school or break time.

The present invention implemented in the educational field is included in a product group of a first technology in the first generation, which provides output-only service (one-way service) such as a low-cost product outputting basic English conversation sentences in voice for elementary student and a high-cost product outputting a word, idiom, phrase, sentence and grammar in voice for preparing a university entry test for high school student which is called as talking English dictionary.

Third, a self-study device for general use in accordance with the present invention is explained in detail.

Recently, workers and housewives have been enthusiastic about learning foreign language however, they could not overcome their limitation of location and time for learning foreign language. Therefore, it increases to demand a product providing a service of self-study method to overcome limitation of location and time.

It is an object of the present invention to provide a small and handy foreign language self-study device by implementing conventional foreign language education appliance including a self-study paper or tape as a semiconductor chip in order to overcome limitation of learning foreign language.

Finally, a self-study device for infant in accordance with the present invention is explained as showing how it applicable as educational appliance to infant.

A market for foreign language educational appliance is sufficient to satisfy enthusiasm about early education of foreign language.

A voice/letter processing apparatus in accordance with the present invention can be quipped a inside of baby appliances such as toy, pillow, cushion and cradle so that conversation sentences of foreign language and a children song is repeatedly played for studying. The voice/letter processing apparatus in accordance with the present invention can be implemented inside of living appliances including a bed, cushion, stand and flower base in order to study music or foreign language in everyday life.

As mentioned above, the present invention can be implemented as semiconductor chip within small and handy case having same functionality of conventional foreign language educational appliances including self-study paper, tape, CD and the present invention can be implemented inside of living appliances such as toy, doll and fancy products. Therefore, the present invention provides a simple and effective method for studying foreign language randomly and repeatedly in anytime and anywhere. It is possible since the present invention provided as small and handy.

According to technical object, a general use of the present invention included in the first technology group can be divided two categories. A first technology group of the present invention in the first generation is a product having one-way functionality. The product has the one-way function that inputs and outputs voice data of a user and outputs on displayer. A second technical object of the present invention in the first generation is a product having two-way functionality. The product of the second technology can receive keypad or short-key input from the user and searches and outputs results according to the user's input.

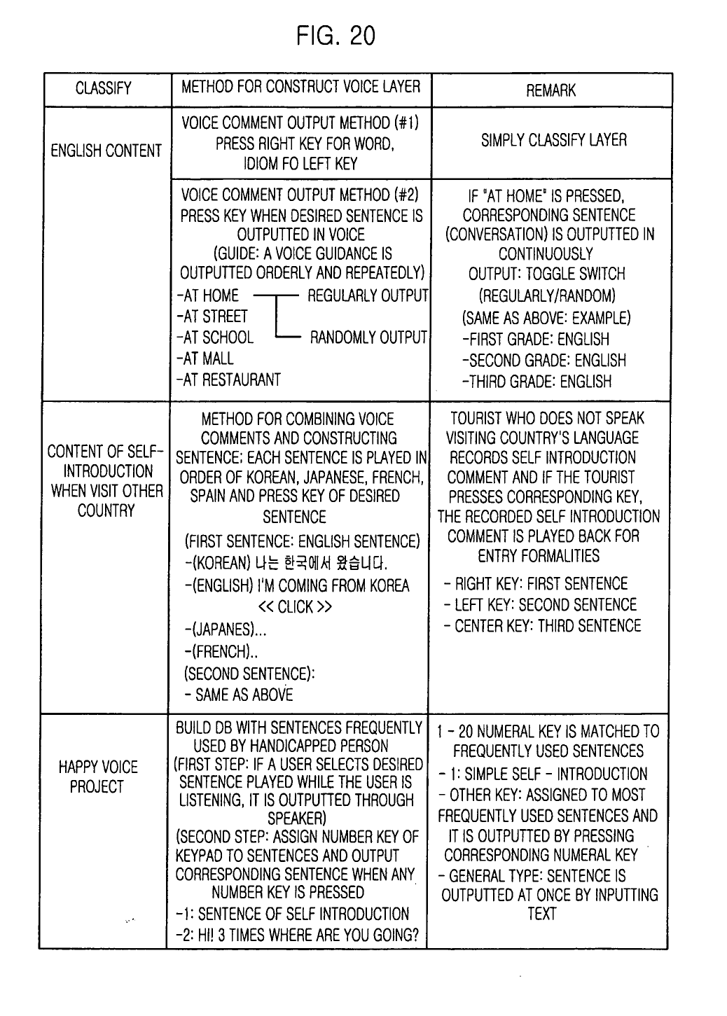

However, in the product group of the first technology in the first generation, an upgrade type of product additionally has functions such as constructing layers of each level with only voice, distinguish content in wide range, input and output results in voice (referring to FIG. 20).

For example, the one way product of the present invention included in the first technology group of the first generation can have additional features including an assistance function (calendar function) and time machine function based on letter/voice input, voice composition, voice recognition and voice output functionalities.

In the two way product of the present invention, which is a product for general use included in the second technology group of the first generation, an assistance function (calendar function) and time machine function based on letter/voice input, voice composition, voice recognition and voice output functionalities are additionally equipped.

The assistance function (assistance and calendar function) equipped in the product group for general use included in the second technology group of the first generation is a function performing a personal assistance functionalities such as outputting a message inputted by user in voice at a predetermined time. The assistance function relates to a technique outputting user's schedule of a day or week in voice according to user's input.

A calendar function in a product for general use included in the second technology of the first generation provides an function to the user for recording user's schedule in the calendar such as inputting a task or message according to data as 24 times in a year (two times in a month) as one year cycle. For example, the user can input a message “go to zoo” on a date, fifth May 2001 and assign to output a voice message according to the input message at 9 o'clock 30 minute at fifth May 2001. On the date, fifth May 2001, the input message “go to zoo” is outputted two times at 9 o'clock 30 minute.

The general use included in the first generation can be divided as four types according to technology implemented in. A first technology of the first generation is a technology providing a one-way service such as outputting context inputted by the user in voice or display on the displayer.

A second technology of the first generation is a technology providing a one-way service such as searching voice information and a word inputted through keypad by user and outputting related sentences.

A third technology of the first generation is a technology for voice outputting method based on an input/output function such as voice compression scheme, voice composition scheme and database scheme for voice information and technology for LCD outputting method. Functions of the third technology can be additionally added to the products of the first and second technology. The third technology of the first generation is a technology constructing each layer by user based on a letter input technology and voice input technology of the first and second technology and outputting a sentence by using a short key.

A product for general use in the third technology of the first generation is a technology providing functions such as a writer interface function for simply compressing voice inputted through cassette tape or microphone by a user or a system (PC) of a service providing agency and storing the compressed voice data. It also includes a function outputting voice of a specific person, which is inputted through keypad and composed by the voice composition function.

The product for general use in the first technology of the first generation is explained in detail as follows.

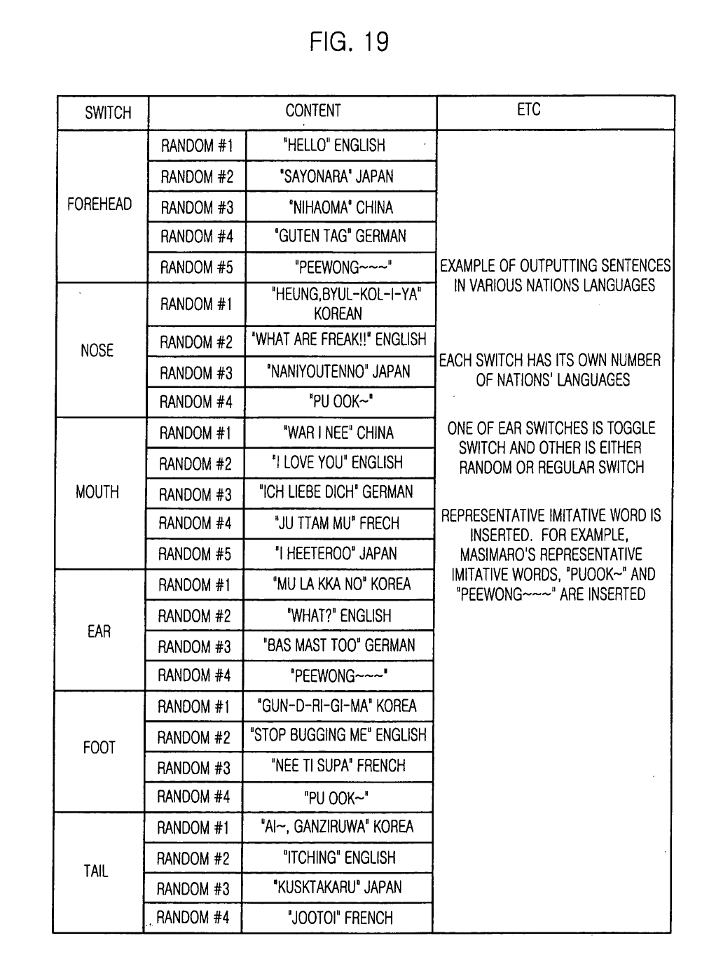

FIG. 19 shows an example of the product for general use in the first technology of the first generation. As referring to FIG. 19, the product is operated by “formulization of language”, which is a switch operation method. That is, if a specific portion of a toy is pressed, corresponding kid-friendly sentence is outputted in voice. Therefore, it may give attraction to children for playing with the toy.

For example, if the children touch a noise of a doll, “I love you” is outputted at first in English and if the children touch the noise of the doll twice, “Ich liebe dich” is outputted in German. It is a random type voice output method that randomly outputs sentences in three different languages in random order among Korean, Japanese, English, German and French.

The random type voice output method of the present invention may output corresponding sentences as voice in order of Korean-Korean-Korean or in order of English-French-Japanese when the noise of the doll is pressed. By outputting sentences as voice in random order of languages according to a random type voice output method program, it may cause to increase a desire of playing with the doll.

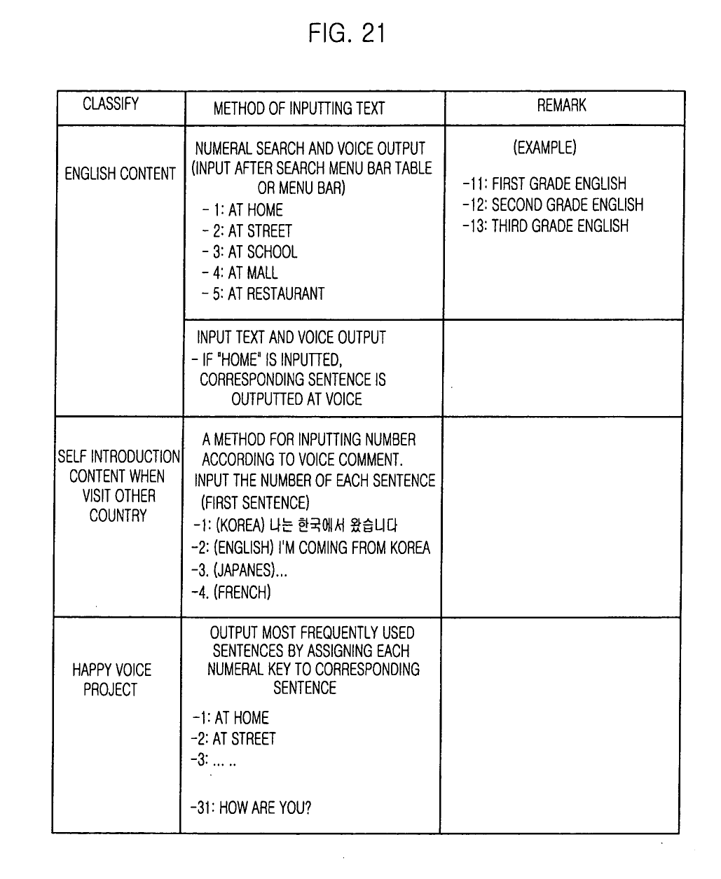

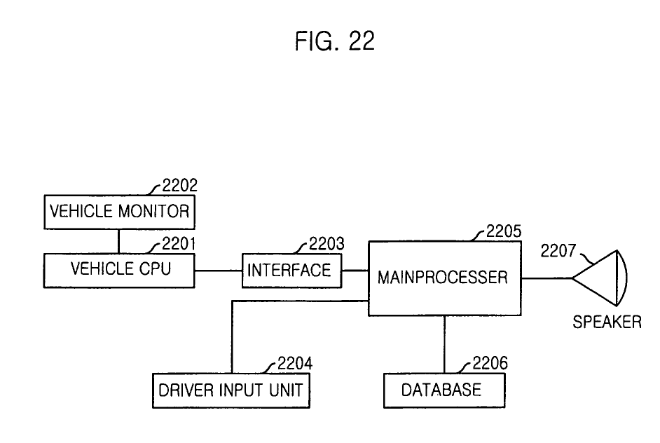

As referring FIG. 21, the random type voice output method includes an imitative word of representative language outputting program. The imitative word of representative language outputting program is a program assigning imitative words, which are loved by children, such as “pow” or “piwoong˜” in various languages to each part of toy and outputting an imitative word corresponding part of the toy in random order. By using the random type voice output method with the imitative word of representative language outputting program, the children may play games such as predicting a specific imitative word, predicting nation of the language or predicting the number of playing during pressing switches on the toy.

The random type voice output method with the imitative word of representative language outputting program can be implemented for adults by assigning imitative words to parts of the toy. They also use the random type voice output method with the imitative word of representative language outputting program as games. For the adult use, the toy can be designed preferably to adult and the random type voice output method with the imitative word of representative language outputting program can be implemented to toy, doll, fancy and gift, which are preferably designed for adult.

The first technology of the first generation used in a product group of general uses for infant is a technique outputting stories and songs in various foreign languages by implementing various sensors into the product for infant such as toys. The first technology for infant products is a technique outputting songs, stories and conversation in various foreign languages by implementing various sensors and semiconductor chips in the products of infants such as a pillow, cushion, bed and cradle.

In products of fancy and gift included in the first technology of the first generation, the semiconductor chips and various sensors are implemented into the products for outputting songs in a random order. A toggle switch is implemented as a part of toy such as ears of doll to output songs or conversation sentences in random order or pre-programmed order by turning the ear. The random type voice output method with the imitative word of representative language outputting program is complementarily implemented in this field.

In products such as fancy and gift, there is a product group dedicated to pass a message. It contains a congratulatory voice message and celebration song. It outputs theme messages in voice for special occasions such as birthday, wedding and love. The random type voice output method can be supplementary implemented in the product group of gift dedicated to pass a message.

The first technology of the first generation for general use can be implemented into an alarm system and language instruction mobile system as shown in FIG. 22.

As referring to FIG. 22, the mobile alarm and language instruction system receives control information from a mobile CPU 2201, searches data corresponding to the received information from voice database and outputs the searched voice database.

The mobile CPU 2201 receives mobile state information such as an engine malfunctioning signal, a seatbelt fasten alarm signal and a fuel empty signal from a mobile monitor 2202. After receiving mobile state information, the mobile CPU 2201 provides it to a main processor 2005 through an interface 2203.

A driver input unit 2004 may include a keypad, voice recognition system and detection sensor. If the driver input unit 2204 includes the keypad, the driver's order information corresponding to the keypad input is transmitted to the main processor 2005. If the driver input unit 2204 includes a voice recognition system, the driver's order information corresponding to the voice input is transmitted to the main processor 2005. The main processor 2005 searches voice data stored in database 2207 based on the received data from the CPU 2201, the driver input unit 2203 and the voice recognition system 2204 and outputs the searched data through a speaker 2208.

The mobile alarm and language instruction system may be modified in various types and be upgraded by adding various functions. For example, a sensor for detecting blood-alcohol level can be supplementary added to the driver input unit 2203 for detecting the blood-alcohol level of the driver and outputting a voice data corresponding to the detected blood-alcohol level as a voice.

The first technology of the first generation in a product group of spiritual gift and collectibles is a technique for outputting voice by building in the semiconductor chip in a regular mode, random mode or toggle mode. It is a product group outputting specific phrases of bible in voice of foreign languages such as Korean, English, Japanese and French by implementing the semiconductor chip inside of the spiritual status. Also, it can be used in Buddhism as same purpose. The above-mentioned product of the first technology of the first generation can be mass-produced for missionary.

The first technology of the first generation in a product group of novelty & souvenir is a product combining a traditional and cultural product with information and communication technology and a technique outputting a voice of various languages such as English, Japanese, French and Chinese by implementing semiconductor chip containing explanation of tourist attractions and traditional songs into the traditional and cultural novelty and souvenir. It can be used as a guide method for foreign tourists.

The first technology of the first generation in a product group for a taxi driver or simple guidance product is a technique outputting simple guiding sentence or comment in various foreign languages. For example, it outputs simple guiding sentences such as “Hello” or “nice to meet you”, “What is the tourist attraction in Seoul?” “Where are you going?”. In the first technology of the first generation, simple guidance comments provided by supplier are outputted in various languages such as English, French or Japanese and the user can update simple sentences by pushing an input key and recording desired sentences with user's a own voice.

In the first technology of the first generation, there is a keypad matching technique for outputting specific conversation sentences such as “Hello?”, “Where are you going?” or “What is the tourist attraction?” by matching 3-5 keypads to conversation sentences and pushing the keypad. It is not limited to Korea and it can be developed according to each country for guiding own traditional and cultural attractions to foreign tourists.

A second technology of the first generation in a product group is explained in detail as follows.

The product group for education in the second technology of the first generation can be an English self-studying device providing English self studying information according to a curriculum of middle/high school for inputting letter and number through a LCD display, searching desired information and outputting the searched information.

The product group in the second technology of the first generation for general use can be an electric diary of raising infant for inputting voice signal through a microphone (or cassette tape) and simply input voice compressing or composing through the writer interface. The electric diary of raising infant can record and store every footsteps of baby such as crying, voice, babble and mimic sound of baby as electric forms and also outputs a voice of baby in a specific past time by searching past record.

A product group of toy for infant in the second technology of the first generation for general use can record a mother's voice in the toy and play back it in a consecutive order or random order at specific time. The product group of toy includes a function for recording mother's voice and a function for synthesizing and compressing audio information from a cassette tape or microphone. And it also contains a function, based on TTS function, for automatically playing voice recorded by the mother or stories inputted by letter at a prefixed time, which is invoked by a timer installed in the toy.

In other words, the present invention provides a method for simply inputting mother's voice or audio information stored in the cassette tape as like as the electric diary of raising infant by using the writer interface and outputting the inputted audio information at a specific time.

The above-mentioned technology of the present invention supports that a mother can record her voice into a doll or toy for infant by herself and the recorded voice information can be compressed and synthesized automatically. Therefore, it can be used to a story telling doll with mother's voice or lullaby toy with mother's voice.

The above-mentioned present invention can be implemented to dolls (calendar doll, message doll) for telling the message as a voice at a specific date and time by a user input message function through input method such as timer, keypad, impact sensor, optical sensor or gravity sensor, a jingler for infant (native language jingler, foreign language jingler) outputting voice, a stand for bedroom for outputting melody or message according to the atmosphere by detecting luminance of bedroom.

A product group in general use of fancy/gift in the second technology of the first generation has a function for receiving user's voice message through a microphone, compressing the received voice message based on an audio compression technique by a program installed inside of the product and outputting the compressed voice message on preset date and time. For example, the user records messages as much as the product can store such as 1 to 20 messages and the product plays the user recorded messages according to an output order at a specific data and time preset by the user. Also, the user inputs desired message in text mode and the inputted text messages are played with famous entertainer's voice, which is provided and installed by the manufacturer.

A product group of fancy calendar/calendar for gift in the second technique of the first generation support to input messages as many as limitation numbers such as 2˜3 time in a month, which is fixed by the manufacturer, by the user with user's voice or a service provide stations to synthesize and input the message into the products by the user's request.

Also, the product group of fancy and gift in the second technique of the first generation has a time-machine function to play old message recoded and played in past data and time. Such the product group of fancy and gift in the second technique targets to market of gift in elementary, middle school and high schoolboys and girls or workers in 20's.

A product group of Religious in the second technique of the first generation support to input desired phrases of Bible, Buddhism or Koran into the product. That is, the context of the bible, tantra or Koran can be recorded into a Christian statue or a bell with wooden tongue by anyone who wants to and such the Christian statue or bell with wooden tongue is used for evangelizing religious. For example, a pastor records phrases of bible into the product of Religious and presents to congregations for evangelizing or a Buddhist priest records a specific preaching into the religious product and presents to Buddhist who was absent in the serving. Also, the product of Religious has a technique to support for recording desired phrases of the Bible into the product by a user and playing back at a specific data and time.

A product group of novelty and souvenir in the second technique of the first generation supports a license permission function for exporting the product or inputting special message in the product in each country. For example, the voice input/output system of the present invention can be implemented inside of elephant sculpture, which is India's traditional sculpture, for inputting and outputting Indian music or guidance messages of India's tourist attractions.

Such the function of the above-mentioned product group can be applicable to a product of novelty and souvenir. A taxi driver or tourist guide can use such the product for recording brief self-introduction or guidance of tourist attractions into the product in native language and playing back the recorded context to the foreign tourists in their native language by pushing a switch on the product.

A product group of wedding gift in the second technology of the first generation provides a function to record a declaration of love or a story of wedding into the wedding gift by a bride and groom or a service provide station with user's request and to play back the recorded content. Also, it has faction to input with text and to output it in voice.

In this case, English sentences for children or random switch input/output system can be implemented into the product group of wedding gift for increasing its value.

A product group of funeral supplies in the second technique of the first generation provides a function to input the deceased's the instruction of departed or family precept in text and to output the inputted content in voice of the deceased based on voice synthesizing with the deceased' voice from other source such as cassette tape of video tape. The deceased's voice can be recorded at the service provide station by synthesizing the voice from other source.

A product group of general use in a third technology of the first generation is a high value added product. An electric English dictionary for preparation of university entering test is one of a product group of educational use in the third technology of the first generation. The electric English dictionary for preparation of university entering test has a function to search word, idiom, phrase, sentence and grammar and to output the searched result as a voice in English according to voice synchronization or compression function.

A “Happy voice” product group in the third technology of the first generation provides a voice output function based on information communication technology to a person who has difficulty in speaking caused by old age, accident or congenital deformity. The voice output function receives text or numeral input by a keypad and outputs corresponding sentence as a voice from the database. The “Happy voice” product group in the third technology of the first generation is a technology to provide a phonating function to the person who has difficulty in speaking of worldwide.

The present invention is a remarkable new idea product for providing rapid and easy communication method with numeral key input to the person who has difficulty in speaking by analyzing and selecting most often or commonly used sentences in normal life, constructing a table with the selected most often or commonly used sentences and providing the table with corresponding voice database.

Additionally, a short key system can be implemented to a keypad of “Happy voice” product. The short keys in the short key system are assigned most often used sentences. For example, 20 different short keys are assigned to corresponding sentences and by simply pressing one of the short keys, a communication can be established easily and rapidly.

The “Happy voice” product includes text input type product having a voice transform output function with text input as a general type product.

A menu bar type product is also included in the “Happy voice” product and it has a function of most often used sentence output system.

A keypad matching product is also included in the “Happy voice” product for the person who has difficulty in speaking and it has a function to input most often used sentence selected and assigned to keys by the user and to output desired sentence by pressing the keys.

The “Happy voice” product includes a number input type product having a function outputting a sentence in voice by pressing a number of sentence when the person who has difficulty in speaking. The sentences are pre-stored in the product by searching most often and commonly used sentences and selecting 20 to 30 sentences.

The “Happy voice” product also supports a message transmit function over wireless and wired communication network and an electric voice output system for the person who has difficulty in speaking over the world.

A product group of calendar in the third technology of the first generation provides personal assistance function for inputting person's schedules in one time on a week or a month with text and outputting the inputted schedules at preset date and time in voice. The product group of calendar supports a text input function for inputting one schedule in a week, total 52 sentences in a year, and voice output function for outputting the inputted schedule in a specific date and time. It can be implemented into a desk clock to perform the personal assistance function of the present invention.

The calendar product of the present invention can be implemented not only the desk clock but also a flower base, telephone, toy, doll or ashtray.

The calendar product group of the present invention can be implemented as a simple and miniature form composed of LCD displayer, keypad and speaker for outputting electric clock and electric calendar to LCD displayer and outputting person's schedule inputted with text in voice at a specific date and time.

The text inputted person's schedule can be outputted in voice of popular entertainers or user's voice by voice synthesizing technique.

A product group of vehicle fancy and supplies in the third technology of the first generation is a toy or doll used as a pennant for decorating interior of vehicle. The product group of vehicle fancy and supplies has a function to output specific sound such as sound of sea, bell sound, specific message or English sentence, whenever the impact sensor detects any sake during driving the vehicle by equipping an impact sensor inside of the product.

A luminance sensor can be equipped inside of the product of vehicle fancy and supplies for outputting Rock, soft Rock, blues music or message inputted by the user according an atmosphere detected by the luminance sensor.

Also, an aromatic can be equipped with the above mentioned functions into the product of vehicle fancy and supplies for spreading the aromatic with music.

The product group of vehicle fancy and supplies can be equipped a random switch voice output system with both the impact sensor and luminance sensor for outputting various type voice or music even aromatics at the same time according to atmosphere and shake during driving the vehicle.

A product group of advertisement in a fifth technique of the first generation has a function to output a short message of cooperation identity or advertisement of related company. Such the function can be implemented inside of above mentioned all product groups such as the educational product group, infant toy group, fancy and gift product group, electric calendar group or vehicle fancy and supplies group.

For example, a short advertisement message of a company can be inserted with fairy tale recorded by mother's voice into the toy for infant and it is outputted randomly. Any types of advertisement message can be inputted to related product such as a wedding supplies company can put their advertisement message into the wedding gift.

The product group of advertisement in the fifth technique of the first generation can be used for election campaign by inserting a message for supporting a specific candidate. It may includes a function outputting campaign speech or political view of the candidate and additional function outputting local information such as restaurant or market so if they show the product at specific restaurant, they may have discount on what they have.

The product group of advertisement in the fifth technology of the first generation can be produced as the product of the vehicle fancy and supplies for outputting special message for advertisement or election campaign with its basic functions. For example, if someone touches a doll, which is the vehicle fancy of the present invention, it outputs the advertisement message with the preset music or short sentence such as “don't touch” or “don't tickling”.

In case that the fourth technology of the first generation of the product group of advertisement is implemented into the toy, it can be multifunctional product having various functions such as cooperation advertisement, related product advertisement, English self-study, unexpected random switch voice output or morning call alarm.

A product group of souvenir of an association of like-minded persons in the fourth technique of the first generation has a function for outputting activity and history of the association or inputting and outputting introductions of new entered members by new members in text. As mentioned above, it can be used for orientation of new members or recruiting new members.

A product group of a community ID in the fourth technology of the first generation is a product used as identification of member in a community by implementing a verification function inside of small doll or toy. The product of a community ID in the fourth technology of the first generation has a function for verifying ID of the member by using an infrared ray sensor, ultrasonic or extremely low power radio. For child member, after verifying the membership, a special sound can be outputted such as barking sound of dog. It may help to increasing friendship between the members.

A product for general use included in a second generation of the present invention is a product of digital joy having all above-mentioned functions of the first, second, third and forth technology of the first generation with wireless communication technology.

The product of digital joy has a function for tracing positioning information between toys and calculating a direction and distance between the toys by transmitting ultrasonic or extremely low power radio, less than 1 mW, and calculating a drift. It can trace positioning information of toy distanced from less than 300 meters.

The product of digital joy provides the function for tracing positioning information between toys distanced less than 300 meters at moderate prices (200 to 300 Won) comparing to GPS system.

The product of digital joy in accordance with the present invention can be used for preventing lost child or searching of lost child and it also can be used for sending and receiving message in close range between members of an association in a school. It also used as a couple toy between friends, mother and child or members of an association.

A function of communication between toys by using infrared rays detection system can be implemented into the product of digital joy.

The product of digital joy with communication function can be provided with other function such as a function for controlling lights in the house and a function for turning on the emergency alarm for children, females and the old and the weak.

A product for general use included in a third generation of the present invention is a product of digital joy in next generation having all above-mentioned functions of the first, second, third and forth technology of the first generation with wired and wireless communication technology.

The product group in a third generation includes a wired/wireless communication product through accessing to wired/wireless network. A “com-toy” product is one of product of third generation and it has a function to access to the computer and download contents.

That is, a first product group of digital joy in next generation has the above-mentioned functions with wired and wireless network and it includes a product having a function performing as a user's terminal for transmitting and downloading data to/from a computer through a wireless network.

A second product group of digital joy in next generation includes a product such as toy having a function as like as a mobile terminal to send and receive data to the mobile phone or computer or to download data from the computer through wireless network.

The second product group of digital joy has a function for text communication, voice communication between toys by accessing to the wireless network. And it also includes a toy having a function for accessing to Internet in order to shopping, game and information searching.

A wireless communication toy of the second product group of digital joy may lead students to establish an association in a school and provides text/voice communication between mother and baby. Therefore, it may become common communication device instead of using the mobile phone.

A product group of general use in a fourth generation is a product of the digital joy in next generation having a function of satellite communication based on the implemented functions in previous generation product.

A satellite communication method is combined with a structure and control method of a protocol of language input/output system of the present invention in the fourth generation. By combining the satellite communication technique, the product of digital joy in fourth generation has a first function for accessing the Internet, playing on-line games, shopping from Web-based shopping mall, a second function for message passing between toys in worldwide with satellite communication technology and a third function for performing same functions as a satellite communication terminal having a function of receiving signal from the satellite.

Technical objects of implementation content of the present invention can be divided to five content groups, a substance of content, expression of content, input/output method of content, external form of content and function of content.

The substance of content also can be divided to two aspects. One is a substance according to curricula curriculum of Elementary, middle and high School and other is a substance containing English conversation according to age bracket.

The expression of content also can be distinguished to two categories. One is an expression method of foreign language in voice of popular entertainers by recording 100 sentences by five different entertainers (20 sentences per person) and play back and other method is a language formalizing method for outputting a sentence of foreign language in voice by pressing a short key of special keypad equipped on a toy. For example, if a nose of the toy is pressed twice, the toy outputs a sentence of “Geeeee, Don't touch my nose” in a popular entertainer's voice. It is implemented in to the toy by considering and reflecting taste of children.

The input/output method of content is divided to two aspects. One is a method outputting common English sentences suitable to age group according to regular time schedule and the other is a method outputting English sentences randomly selected by a random generator. It is one of major functions of the present invention.

The external form of content is divided to five categories. One is a method of implementing the present invention into a digital game system. Second is a method of implementing the present invention into a toy and the present invention can be implemented into doll, fourth is fancy and fifth is a method of implementing the present invention into a living appliance.

Detailed explanation of functionality of content is explained hereinafter.

One of functionalities of content in educational use of the present invention is one-way communication product. It outputs or displays content provided by the manufacturer. It is an early product of the present invention and it outputs content such as English sentence in regularly or randomly.

The one-way communication product included in educational use of the present invention has a one-way function only outputting foreign language sentence inputted by manufacturer. It has ROM type memory that can store one hundred to one thousand of English sentences.

Next product of the present invention has a function of two-way communication. A user can search and output sentences related to word inputted by using a keypad or short key. It searches and outputs desired sentences from database based on a word inputted by the user.

The product having a function of two-way communication supports a multi-layer for easy search by implementing multi-layer in word, idiom and sentence.

The product for educational use includes a product group of one-way communication function, product group of two-way communication function and enhanced function product group searching and outputting simply and easily with new technology and combining technology of previous product's functions.

The two-way communication product for educational use includes a program for correcting English pronunciation by setting point according to clarity of English pronunciation, analyzing user's inputted English pronunciation and giving point according to analyzed result and a function to output foreign sentence according to a layer selected by voice input.

The present invention provides an effective method to study foreign language having no limitation of location and time by compressing and storing desired foreign language sentence into semiconductor chip and playing back the stored foreign language sentence in voice or text instead of using a convention self-study media such as Tape, VTR or TV.

The above-mentioned present invention increases effectiveness of education of infant, preschool student and children to learn foreign language by minimizing denial of foreign language and increasing familiarity of foreign language. Also, the user can learn foreign language during playing with the toys.

While the present invention has been described with respect to certain preferred embodiments, it will be apparent to those skilled in the art that various changes and modifications may be made without departing from the scope of the invention as defined in the following claims.

1. A portable voice/letter processing apparatus, comprising of:
input means for receiving data from outside;
store means for storing compressed data;
control means for generating a control signal in order to search data stored by the store means according to data inputted from the input means; and
output means for recovering the compressed data to be recognized by the user according to the control signal and outputting the recovered data.

2. The apparatus as recited in claim 1, wherein the store means includes a program table, chapter table, paragraph table, sentence table and key-word table.

3. The apparatus as recited in claim 2, wherein the program table includes a chapter index, paragraph index, sentence index and key-word index.

4. The apparatus as recited in claim 3, wherein the output means includes a voice output device for outputting voice data.

5. The apparatus as recited in claim 4, wherein the output means further includes a display unit for displaying data inputted from a user and the data searched according to the data inputted from a user.

6. The apparatus as recited in claim 5, further including a repetition playback means for selecting desired voice data among voice data outputted and repeatedly playing back the selected voice data.

7. The apparatus as recited in claim 5, further including a communication means for accessing to the Internet in order to perform Internet information search, on-line game, Web-surfing and e-mail.

8. The apparatus as recited in claim 5, wherein the control means outputs a sentence in native language (Korean) and a sentence in foreign language corresponding to the sentence of native language (Korean) in order.

9. The apparatus as recited in claim 5, wherein the control means controls to simply output a recorded content for information transmission.

10. The apparatus as recited in claim 5, wherein the control means control to output voice data scheduled at a specific date and time.

11. The apparatus as recited in claim 5, wherein the control means controls to output voice data by generating a random service through a random number generator in case the random service is set up and outputting voice data according to an order and condition of the random service.

12. The apparatus as recited in claim 3, wherein the input means includes a text input means.

13. The apparatus as recited in claim 12, further including a text-voice conversion means for converting text data inputted from the text input means to voice in order to output.

14. The apparatus as recited in claim 3, the input means includes a voice input means.

15. The apparatus as recited in claim 13, further including a voice-text conversion means for converting voice data inputted from the voice input means to text in order to output.

16. The apparatus as recited in claim 3, the input means includes a sense means.

17. The apparatus as recited in claim 15, the sense means is a touch sensor for sensing the touch when a user touches the touch sensor, generating an on/off signal and applying the on/off signal to the control means.

18. The apparatus as recited in claim 15, wherein the sense means is an impact sensor for sensing the impact, generating an on/off signal and applying the on/off signal to the control means.

19. The apparatus as recited in claim 15, wherein the sense means is an impact and contact sensor for sensing shake caused by wind, impact or contact, not caused from user's touch, generating an on/off signal and applying the on/off signal to the control means.

20. The apparatus as recited in claim 15, wherein the sense means is an ultrasonic sensor for sensing a distance from the user, generating an on/off signal and applying the on/off signal to the control means.

21. The apparatus as recited in claim 15, wherein the sense means is a frequency sensor for sensing identical frequency to calculate a distance from the user or between the apparatuses, generating an on/off signal and applying to the on/off signal to the control means.

22. The apparatus as recited in claim 15, wherein the sense means is a luminance sensor for sensing luminance of atmosphere around the apparatus, generating an on/off signal and applying to the on/off signal to the control means.

23. The apparatus as recited in claim 15, wherein the sense means is a timer sensor for generating an on/off signal according to a timer equipped inside of the apparatus and applying the on/off signal to the control means.

24. The apparatus as recited in claim 15, wherein the sense means is a random generate sensor for applying an on/off signal generated from the random generator equipped inside of the apparatus to the control means.

25. The apparatus as recited in claim 15, wherein the sense means is a voice sensor for sensing voice received to the apparatus, generating an on/off signal according to the detected voice and applying the on/off signal to the control means.

26. The apparatus as recited in claim 15, wherein the sense means is a gravity sensor for sensing gravity pressed to the apparatus, generating an on/off signal according to the sensed gravity and applying the on/off signal to the control means.

27. The apparatus as recited in claim 15, wherein the sense means is a temperature sensor for sensing a temperature around of the apparatus, generating an on/off signal according to the sensed temperature and applying the on/off signal to the control means.

28. The apparatus as recited in claim 15, wherein the sense means is a substance sensor for sensing a substance touched to the apparatus, generating an on/off signal according to the sensed substance and applying the on/off signal to the control means.

29. The apparatus as recited in claim 15, wherein the sense means is a toggle switch sensor for sensing an on/off signal generated by a toggle switch and applying the on/off signal to the control means.

30. The apparatus as recited in claim 11, wherein the text input means includes a keypad.

31. The apparatus as recited in claim 11, wherein the text input means includes a keyboard.

32. The apparatus as recited in claim 1, wherein the input means receives information from vehicle central processing unit (CPU).

33. The apparatus as recited in claim 31, wherein the input means receives user information through a driver input unit.

34. The apparatus as recited in claim 32, wherein the driver input unit includes a keypad.

35. The apparatus as recited in claim 32, wherein the driver input unit includes a voice recognition sensor.

36. The apparatus as recited in claim 32, wherein the driver input unit includes a sensor for detecting alcohol density in user's blood.
